(19) United States
(12) Patent Application Publication
(10) Pub. No.: US 2009/0134194 A1
(43) Pub. Date: May 28, 2009

(54) STAPLER FOR USE WITH SHAPED OBJECTS

(75) Inventors: Richard Maksimoski, Columbus, OH (US); Brian King, Columbus, OH (US); Ryan Erickson, Columbus, OH (US)

Correspondence Address: MCNEES WALLACE & NURICK LLC, 100 PINE STREET, P.O. BOX 1166, HARRISBURG, PA, 17108-1166, US

(73) Assignee: Elmer's Products, inc.., Columbus, OH (US)

(21) Appl. No.: 12/277,954

(22) Filed: Nov. 25, 2008

Related U.S. Application Data
(60) Provisional application No. 60/990,139, filed on Nov. 26, 2007.

(51) Int. Cl. B25C 5/02; A41H 37/10; B27F 7/00

(52) U.S. Cl. 227/120; 227/18; 227/109

(57) ABSTRACT

A stapling system for dispensing both staples and shaped objects is provided. This system includes at least one item to be stapled; at least one shaped object, wherein the at least one shaped object is adapted to receive at least one staple; at least one staple; and a stapling device, wherein the stapling device is adapted to contain both the at least one shaped object and the at least one staple; wherein upon actuating the stapling device both the at least one shaped object and the at least one staple are dispensed from the stapling device; and wherein upon dispensation from the stapling device, the staple cooperates with the shaped object to attached the shaped object to the surface of the item to be stapled.

### CROSS-REFERENCE TO RELATED APPLICATIONS

This patent application claims the benefit of U.S. Provisional Patent Application Ser. No. 60/990,139 filed on Nov. 26, 2007, and entitled “Stapler for Use with Shaped Objects,” the disclosure of which is incorporated by reference as if fully rewritten herein.

### BACKGROUND OF THE INVENTION

The present invention relates generally to staplers, and more specifically to a stapling system that includes a stapler which has been modified to receive a uniquely shaped object that is dispensed from the stapler when the stapler is actuated.

Staplers are common items in many households, classrooms, and offices and are commercially available from various sources. The staplers that are available are typically useful for attaching multiple pieces of paper to one another. However, there are few, if any, staplers that provide a user with the ability to customize documents and make their appearance unique. For example, if a consumer wants to include a company logo on various papers, that person usually must print out the company logo on the paper or use printed letter-head. Therefore, while various known devices are useful for stapling together paper and other items, a need exists for a stapling system that includes uniquely shaped objects that cooperate with common staples to effectively bind together papers (or other items) while also providing decoration to the surface of the paper.

### SUMMARY OF THE INVENTION

The following provides a summary of exemplary embodiments of a stapler system according to the present invention. This summary is not an extensive overview and is not intended to identify key or critical aspects or elements of the present invention or to delineate its scope.

The present invention provides a solution to consumers that wish to place identifying indicia, such as company logos on paper, as opposed to simply using company letter head. Furthermore, the present invention allows a consumer to easily attach items, such as a company logo to a document to make the appearance of the document unique. In accordance with one aspect of the present invention, a stapling system is provided. This stapling system includes: at least one item to be stapled; at least one shaped object, wherein the at least one shaped object is adapted to receive at least one staple; at least one staple; and a stapling device, wherein the stapling device is adapted to contain both the at least one shaped object and the at least one staple; wherein upon actuating the stapling device both the at least one shaped object and the at least one staple are dispensed from the stapling device; and wherein upon dispensation from the stapling device, the staple cooperates with the shaped object to attached the shaped object to the surface of the item to be stapled.

In accordance with another aspect of the present invention, a stapler is provided. This stapler includes a plurality of shaped objects storable in the stapler; a plurality of staples storable in the stapler; and a body, wherein the body further comprises: a top portion hingably attached to a bottom portion, wherein the top portion further comprises a first housing adapted to receive and dispense the plurality of staples, wherein the bottom portion further comprises a second housing adapted to receive and dispense the least one shaped object, and wherein the shaped object cooperates with a single staple in the plurality of staples for attaching the shaped object to the surface of an item when the stapler is actuated.

In yet another aspect of this invention, a stapling system is provided. This stapling system includes a plurality of shaped objects, a plurality of staples, and a stapler for dispensing the plurality of staples. The stapler further includes a top portion hingably attached to a bottom portion. The bottom portion further comprises a first housing which is adapted to receive and dispense the plurality of staples. The top portion further comprises a second housing which is adapted to receive a plurality of shaped objects or a strip or cartridge of shaped objects to be dispensed. When the stapler is actuated, an individual shaped object in the plurality of shaped objects cooperates with a single staple in the plurality of staples for attaching the shaped object to the surface of an item.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1a is a front, perspective view of a first exemplary embodiment of the stapler of the present invention;

FIG. 1b is a front, perspective view of a single staple cooperating with a shaped object in accordance with the first exemplary embodiment of the present invention;

FIG. 2 is a rear, perspective view of the stapler of FIG. 1;

FIGS. 3a-c are top, side, and front views respectively of the stapler of FIG. 1;

FIG. 4 is a front, perspective view of the first exemplary embodiment, wherein the stapler includes an auto-feeding device for use with the plurality of shaped objects;

FIG. 5 is a front, perspective view of a second exemplary embodiment of the stapler of the present invention;

FIG. 6 is a front, perspective view of a single staple cooperating with a shaped object in accordance with the second exemplary embodiment of the present invention;

FIGS. 7-9 are top, perspective views of a second exemplary embodiment of the stapler of the present invention showing the placement of a cartridge of shaped objects within the second housing of the stapler;

FIG. 10 illustrates the proper placement of a sheet of paper within the stapler of the present invention; and

FIG. 11 is a front, perspective view of the secondary embodiment of the stapler, wherein the stapler includes a cutter for cutting a strip or cartridge of shaped objects.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates to a stapling system that includes uniquely shaped, geometric objects for deposition on flat surfaces. As previously indicated, a first general embodiment of this invention provides a stapling system for use with at least one shaped object and at least one staple, wherein the shaped object is located in the bottom portion of the stapler prior to dispensing; and a second general embodiment of this invention provides a stapling system for use with a plurality of shaped objects and a plurality of staples, wherein the shaped object is located in the top portion of the stapler prior to dispensing. With reference now to the Figures, one or more specific embodiments of this invention shall be described in greater detail.

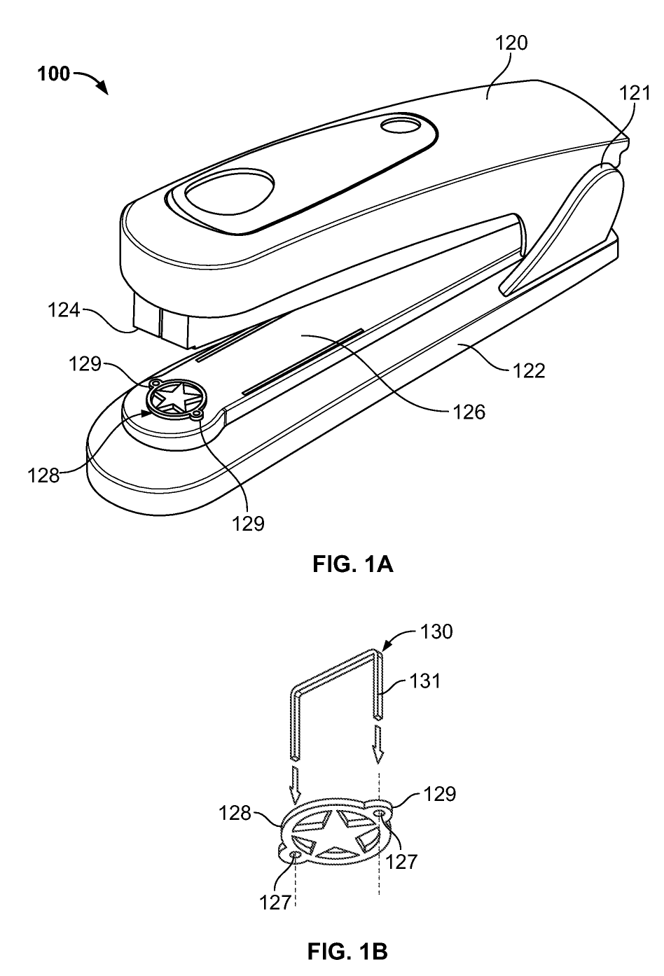

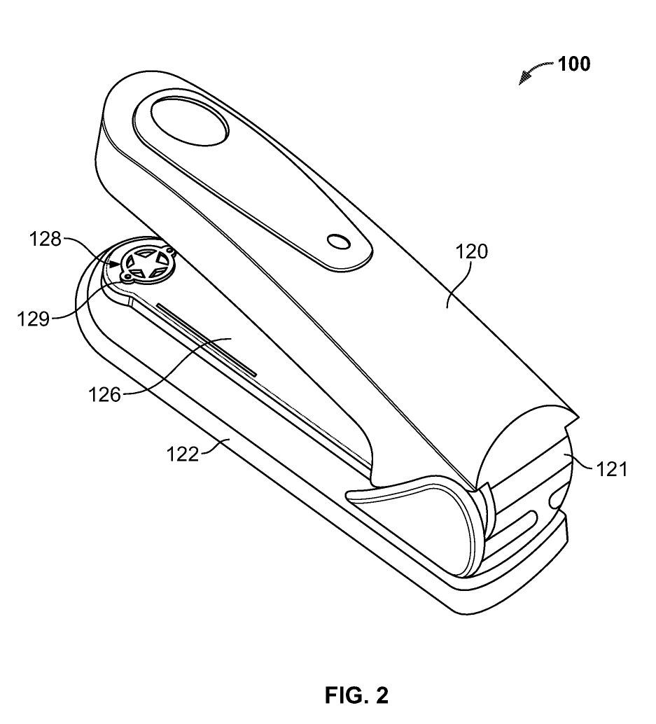

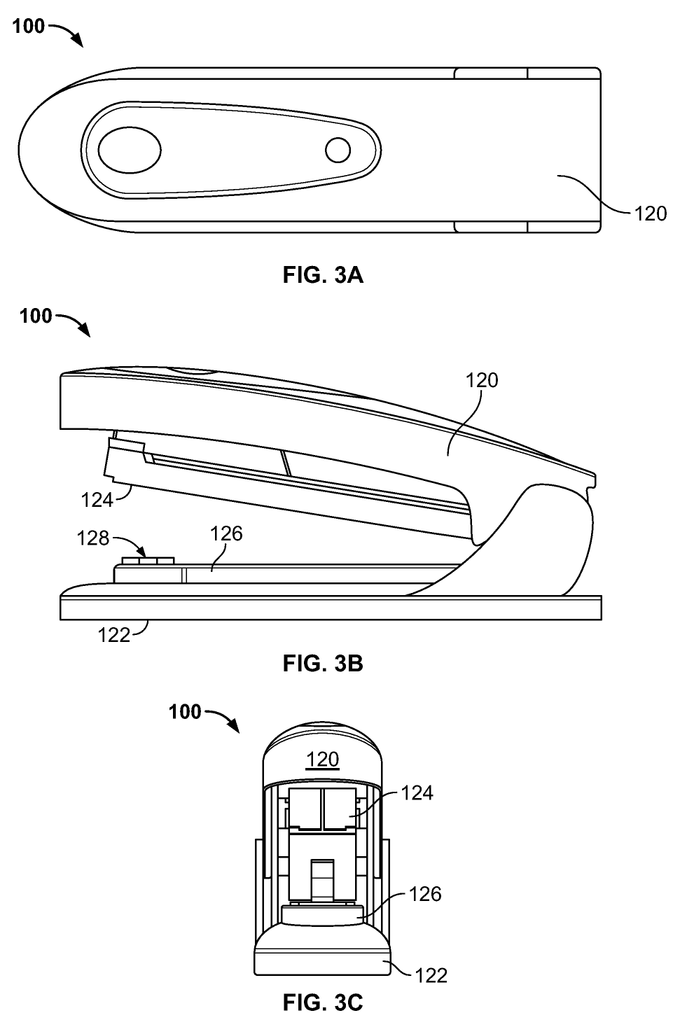

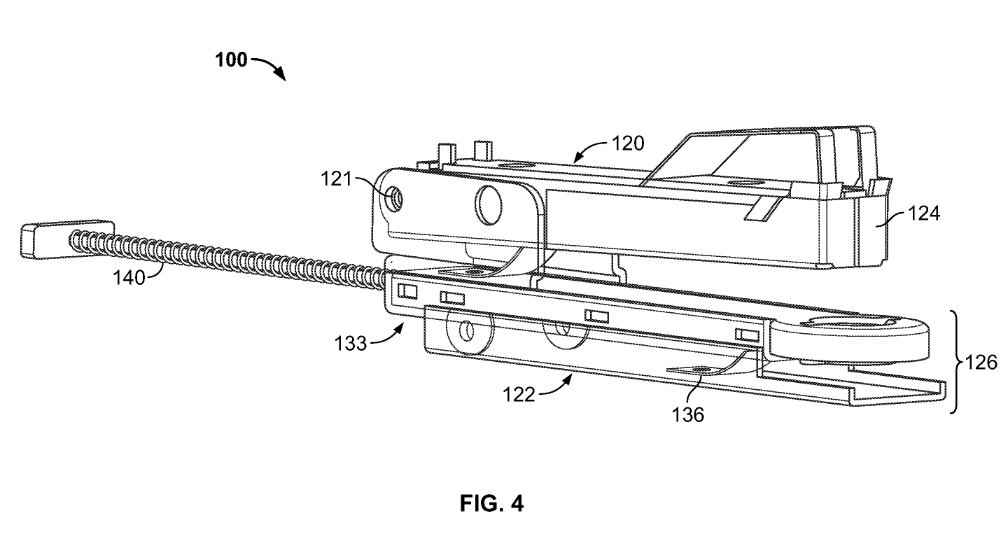

FIG. 1a provides a front, perspective view of a first exemplary embodiment of stapler 100. In this embodiment, stapler 100 includes a top portion 120, which is attached by hinge or other flexible means 121 to bottom portion 122. A modified stapling mechanism is partially enclosed within top and bottom portions 120 and 122 respectively and includes a first housing 124 for holding at least one staple 130 (or a plurality of staples), and a base 126, which is modified to receive a shaped object 128. In this exemplary embodiment, base 126 is configured to receive only one shaped object 128. FIG. 2 provides a rear, perspective view of the stapler 100, shown in FIG. 1. FIGS. 3a-c provide alternate views of the first exemplary embodiment. Specifically, FIG. 3a provides a top view, FIG. 3b provides a side view, and FIG. 3c provides a front view of this embodiment.

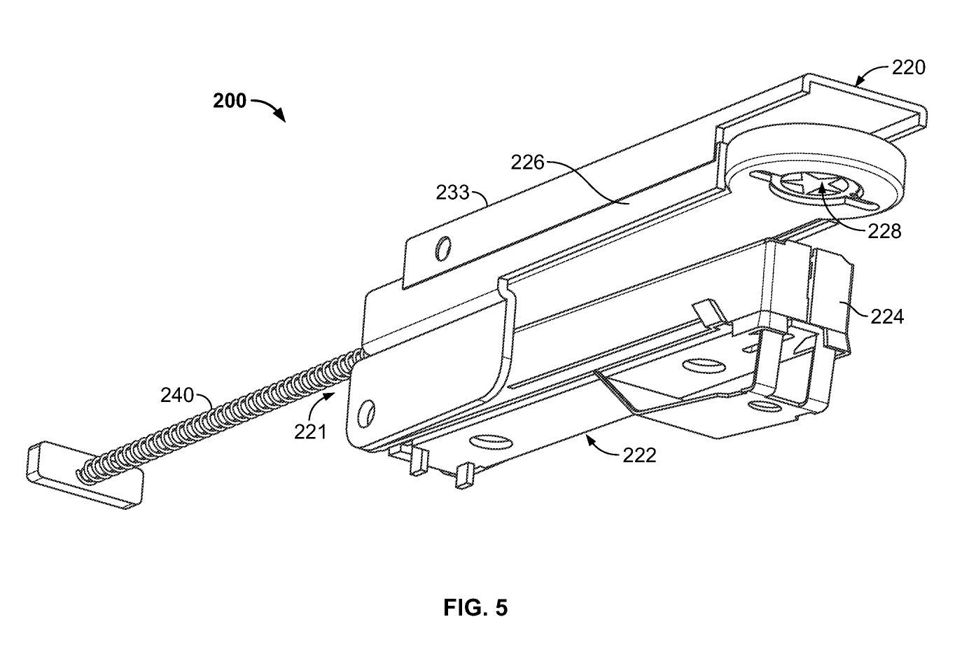

FIG. 4 provides a front perspective view of a second version of the first exemplary embodiment of stapler 100; however, in this version, the stapler 100 is configured to hold a plurality of shaped objects 128, and base 126 contains an auto-feeding device 133 for automatically advancing shaped objects 128 into and through stapler 100. In this embodiment, stapler 100 includes a top portion 120, which is attached by hinge means 121 to bottom portion 122. A modified stapling mechanism is partially enclosed within top and bottom portions 120 and 122 respectively and includes a first housing 124 for holding a plurality of staples 130 and a base 126, which is modified to receive a plurality of shaped objects 128 and also contains auto-feeding device 133. Shaped objects 128 are loaded into auto-feeding device 133, which is mounted on, attached to, or formed integrally with base 126 of stapler 100. The auto-feeding device 133 may be a spring-loaded apparatus or may include a strip of shaped objects 128 that mechanically advance, one at a time, into the proper position in base 126 each time stapler 100 is actuated. This version permits the user of stapler 100 to staple multiple items without reloading an individual shaped object 128 for each stapling job. Auto-feeding device 133 may also contain a push rod 140 to manually advance shaped objects 128 into and though base 126 (see FIG. 4).

In both versions of the first exemplary embodiment described above, stapler 100 functions in a similar manner. Shaped object 128 includes two lateral protrusions 129, each having an aperture 127 passing completely therethrough. Protrusions 129 assist in stabilizing shaped object 128 in base 126 and aperture 127, which passes through each protrusion 129 is designed to receive a portion of staple 130 when stapler 100 is actuated. As best shown in FIG. 1b, when stapler 100 is actuated, vertical arms 131 of wire staple 130 extend into and through apertures 127 in protrusions 129 and are then bent to attach staple 130 to shaped object 128. When in use, staples 130 are loaded into first housing 124, a particular shaped object 128 is placed into the cavity formed in base 126, two sheets of paper or other material are inserted into stapler 100, and stapler 100 is depressed or compressed by a user thereof. A staple 130 exits housing 124, passes through the paper sheets and engages, i.e., clinches, shaped object 128. Thus, when the paper is removed from stapler 100, shaped object 128 will be attached to the surface of one of the pieces of paper where, presumably, it (and anything printed or formed thereon) will be clearly visible.

Shaped object 128 may include any of a wide variety of geometric shapes and designs including corporate logos, product logos, brand logos, and team logos. Numerous decorative shapes such as, for example, stars, hearts, diamonds, squares, circles, squares, and triangles are also possible. Shaped objects 128 may be made from metal, plastic, or other suitably rigid and durable materials and may be manufactured or fabricated using known stamping or molding processes or any other suitable process. These examples are illustrative in nature, and are not intended to be limiting in any way.

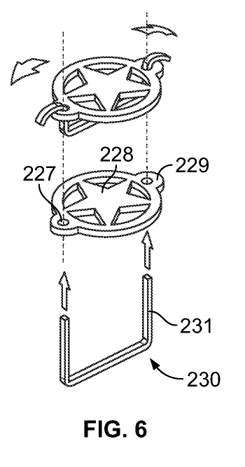

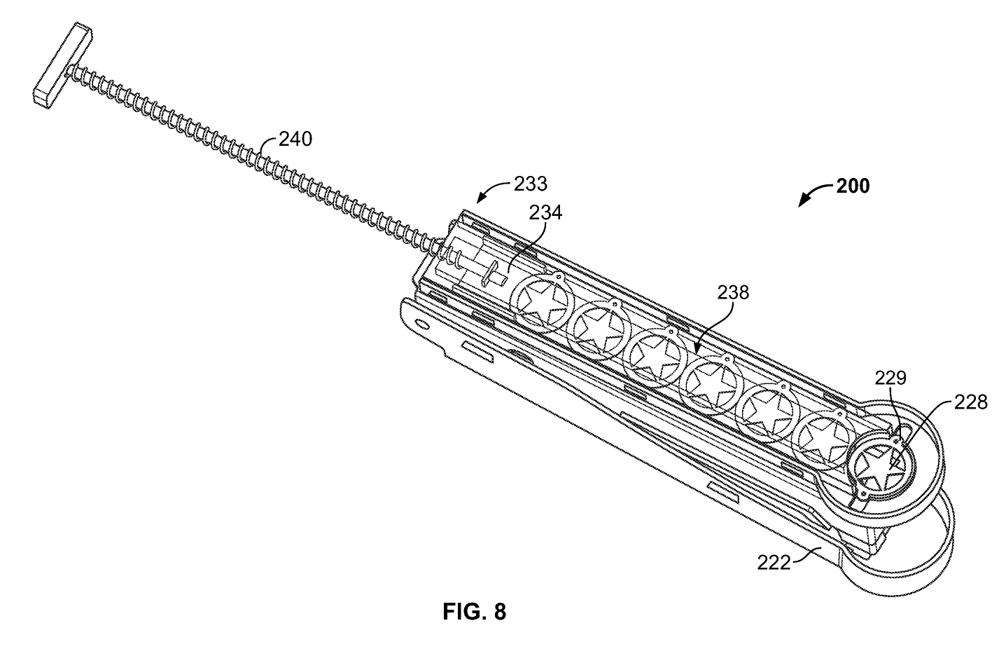

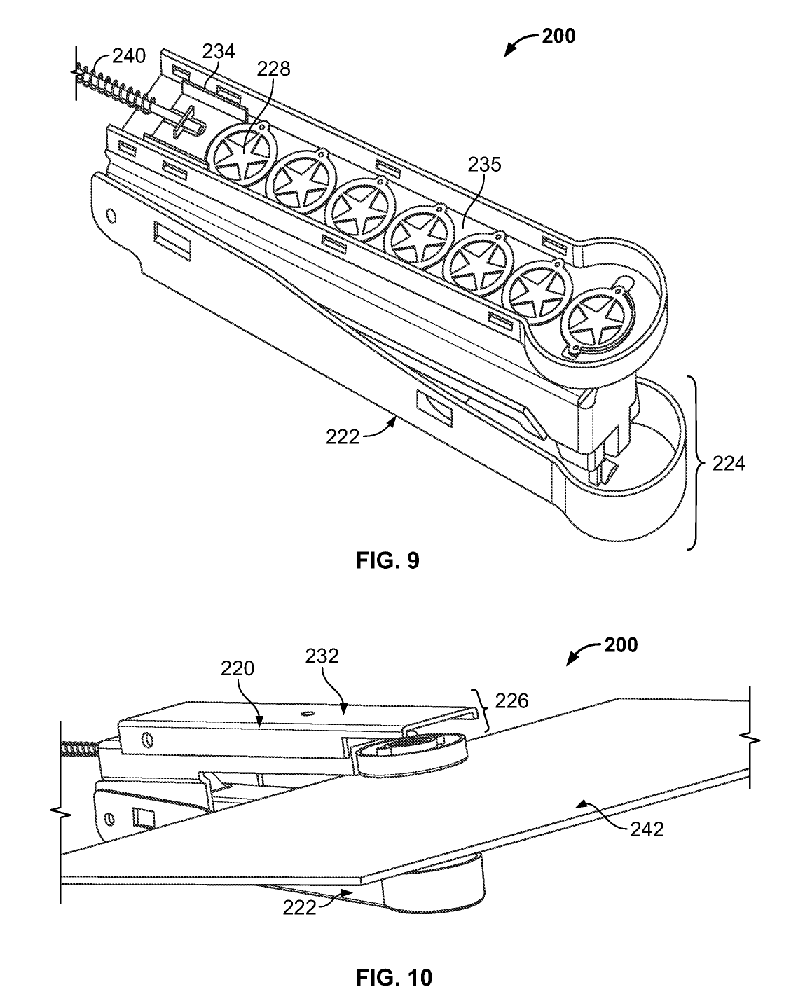

FIGS. 5-11 illustrate a second exemplary embodiment of stapler 200. FIG. 5 provides a front, perspective view of a second exemplary embodiment of stapler 200. In this embodiment, stapler 200 includes a top portion 220, which is attached by hinge or other flexible means 221 to bottom portion 222. A modified stapling mechanism is partially enclosed within top and bottom portions 220 and 222 respectively. As shown in the Figures, bottom portion 222 includes a first housing 224 for holding at least one staple 230 (or a plurality of staples 230) and top portion 220 includes a second housing 226, which is modified to receive a plurality of shaped objects 228, wherein the plurality of shaped objects 228 may be in the form of a strip or cartridge. The plurality of shaped objects 228 is loaded into an auto-feeding device 233 mounted on, attached to, or formed integrally with the body of stapler 200. Auto-feeding device 233 may be a spring-loaded apparatus or may include a strip of shaped objects 228 that mechanically advances into the proper position in second housing 226 each time stapler 200 is actuated. Second housing 226 has an outer cover 232 (shown in FIG. 7) which surrounds auto-feeding device 233. Auto-feeding device 233 includes a channel 235 (shown in FIG. 9) for receiving shaped objects 228. As shown in FIG. 9, shaped objects 228 are held in place in channel 235 by a push board 234 that prevents shaped objects 228 from exiting channel 235 or from moving undesirably in channel 235. As illustrated in FIGS. 7-9, a user can advance shaped objects 228 through channel 235 of auto-feeding device 233 by applying pressure to push rod 240, which is attached to push board 234. A metal spring sheet 236 (shown in FIG. 7) separates cover 238 (shown in FIG. 8) of auto-feeding device 233 from outer cover 232 of second housing 226.

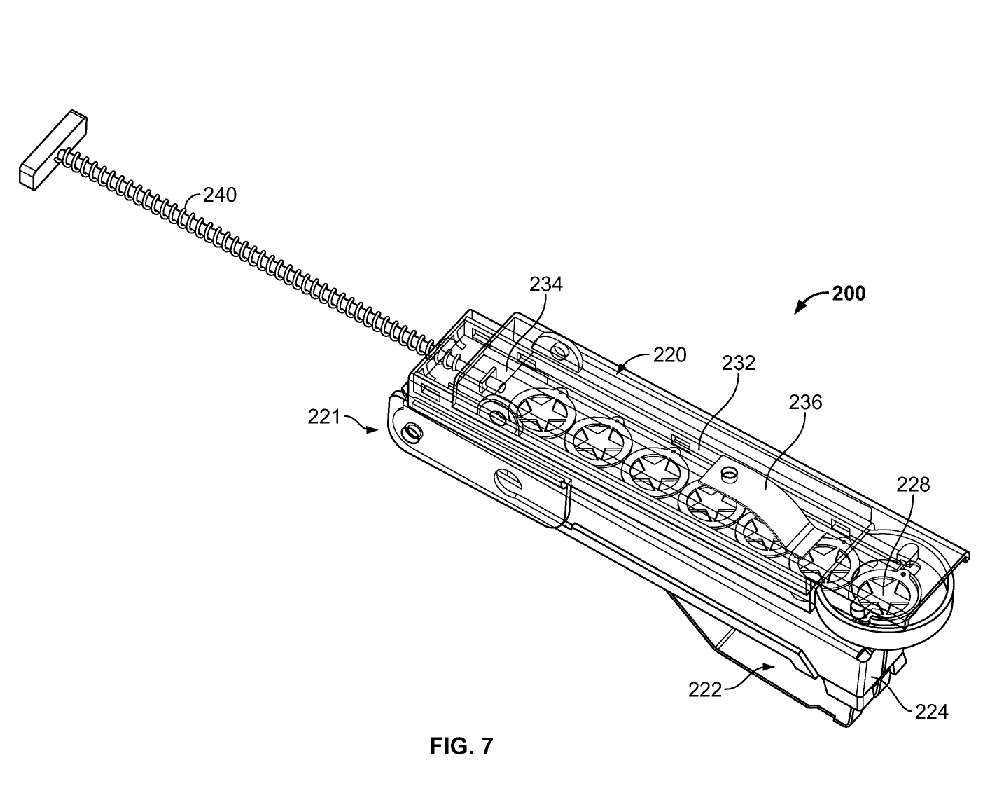

As shown in FIG. 6, shaped object 228 includes two lateral protrusions 229, each having an aperture 227 passing completely therethrough. When stapler 200 is actuated, vertical arms 231 of wire staple 230 extend into and through apertures 227 in protrusions 229 and are then bent to attach staple 230 to shaped object 228. Protrusions 229 assist in stabilizing shaped object 228 in second housing 226, and aperture 227, which passes through each protrusion 229, is designed to receive a portion of staple 230 when stapler 200 is actuated. When in use, staples 230 are loaded into first housing 224, shaped objects 228 are loaded into second housing 226 containing a channel 235 and two sheets of paper 242 or other material are inserted into stapler 200, and stapler 200 is depressed or compressed by a user thereof. Staple 230 exits housing 224, passes through paper 242 and engages, i.e., clinches, the shaped object 228. Thus, when the paper 242 is removed from stapler 200, shaped object 228 will be attached to the surface of one of the pieces of paper 242 where, presumably, it (and anything printed or formed thereon) will be clearly visible. In this embodiment, the vertical arms 231 of staple 230 are folded outwards to allow shaped object to be fully visible. This embodiment also permits the user of stapler 200 to staple multiple items without loading an individual shaped object 228 for each stapling job.

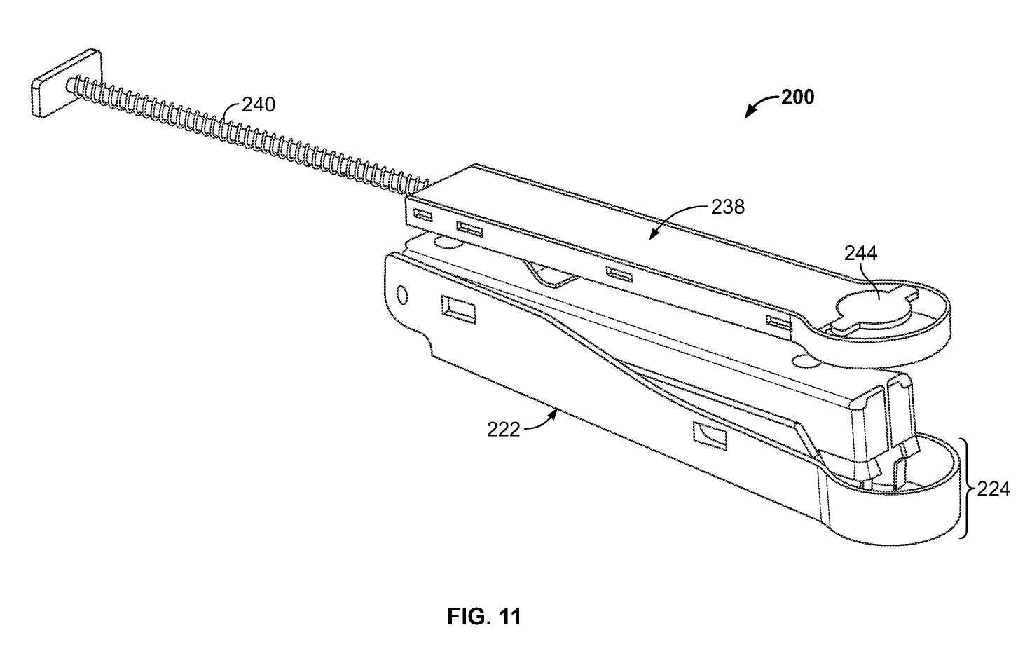

Alternatively, stapler 200 can be configured with a cutter 244 (see FIG. 11), for cutting out shaped object 228 from a cartridge or strip of shaped objects (not shown in the figures) that are loaded into channel 235. When a user actuates stapler 200, cutter 244 cooperates with strip or cartridge of shaped objects 228 to cut or punch out the shaped object 228 to be attached to paper. As shown in FIG. 6, shaped object 228 includes two lateral protrusions 229, each having an aperture 227 passing completely therethrough. When stapler 200 is actuated, the vertical arms 231 of wire staple 230 extend into and through apertures 227 in protrusions 229 and are then bent to attach shaped object 228 to staple 230. Protrusions 229 assist in stabilizing shaped object 228 in second housing 226 and aperture 227, which passes through each protrusion 229 is designed to receive a portion of staple 230 when stapler 200 is actuated. When in use, staples 230 are loaded into first housing 224, a strip or cartridge of shaped objects 228 are loaded into second housing 226 containing channel 235 and cutter 244, two pieces or sheets of paper 242 or other material are inserted into stapler 200, and stapler 200 is depressed or compressed by a user thereof. As stapler is being depressed or compressed, cutter 244 cuts or punches out the shaped object 228 from the strip or cartridge of shaped objects, staple 230 exits first housing 224, passes through paper 242 and engages, i.e., clinches, the cut shaped object 228. Thus, when the paper 242 is removed from stapler 200, shaped object 228 will be attached to the surface of one of the pieces of paper 242 where, presumably, it (and anything printed or formed thereon) will be clearly visible. This embodiment also permits the user of stapler 200 to staple multiple items without loading an individual shaped object 228 for each stapling job.

Shaped object 228 may include any of a wide variety of geometric shapes and designs including corporate logos, product logos, brand logos, and team logos. Numerous decorative shapes such as, for example, stars, hearts, diamonds, squares, circles, squares, and triangles are also possible. Shaped objects 228 may be made from metal, plastic, or other suitably rigid and durable materials and may be manufactured or fabricated using known stamping or molding processes or any other suitable process. These examples are illustrative in nature, and are not intended to be limiting in any way.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A stapling system, comprising:
(a) at least one item to be stapled;
(b) at least one shaped object, wherein the at least one shaped object is adapted to receive at least one staple;
(c) at least one staple; and
(d) a stapling device, wherein the stapling device is adapted to contain both the at least one shaped object and the at least one staple; wherein upon actuating the stapling device both the at least one shaped object and the at least one staple are dispensed from the stapling device; and wherein upon dispensation from the stapling device, the staple cooperates with the shaped object to attached the shaped object to the surface of the item to be stapled.

2. The stapling system of claim 1, wherein the stapling device further comprises a top portion attached to a bottom portion wherein the top portion further includes a first housing adapted to receive the at least one staple and wherein the bottom portion further includes a base to receive the at least one shaped object.

3. The stapling system of claim 1, wherein in the at least one shaped object is plastic or metal and further comprises decorative geometric shapes selected from the group consisting of stars, hearts, diamonds, squares, circles, triangles or designs such as corporate logos, product logos, brand logos, and team logos.

4. The shaped object of claim 3, wherein the at least one shaped object further comprises at least one lateral protrusion for stabilizing the shaped object in the base of the stapling device and wherein the lateral protrusion further comprises at least one aperture passing therethrough for receiving a portion of the staple.

5. A stapler, comprising:
(a) a plurality of shaped objects storable in the stapler;
(b) a plurality of staples storable in the stapler; and
(c) a stapler body, wherein the body further comprises a top portion hingably attached to a bottom portion, wherein the top portion further comprises a first housing adapted to receive and dispense the plurality of staples, wherein the bottom portion further comprises a second housing adapted to receive and dispense the least one shaped object, and wherein the shaped object cooperates with a single staple in the plurality of staples for attaching the shaped object to the surface of an item when the stapler is actuated.

6. The stapling system of claim 5, wherein in the at least one shaped object is plastic or metal and further comprises decorative geometric shapes selected from the group consisting of stars, hearts, diamonds, squares, circles, triangles or designs such as corporate logos, product logos, brand logos, and team logos.

7. The shaped object of claim 6, wherein the shaped object is included in a plurality of shaped objects provided in a cartridge or sheet of shaped objects.

8. The stapling system of claim 5, further comprising an auto-feeding device for dispensing the at least one shaped object, wherein the auto-feeding device forms an integral part of the second housing of the stapler.

9. The shaped object of claim 6, wherein the at least one shaped object further comprises at least one lateral protrusion for stabilizing the shaped object in the base of the stapling device and wherein the lateral protrusion further comprises at least one aperture passing therethrough for receiving a portion of the staple.

10. A stapler, comprising:
(a) a plurality of shaped objects storable in the stapler;
(b) a plurality of staples storable in the stapler; and
(c) a stapler body further comprising a top portion hingably attached to a bottom portion, wherein the bottom portion further comprises a first housing adapted to receive and dispense a plurality of staples, wherein the top portion further comprises a second housing adapted to receive and dispense at least one shaped object, wherein the shaped object cooperates with a single staple in the plurality of staples for attaching the shaped object to the surface of an item when the stapler is actuated.

11. The stapling system of claim 10, wherein in the shaped object further comprises decorative geometric shapes selected from the group consisting of stars, hearts, diamonds, squares, circles, triangles or designs such as corporate logos, product logos, brand logos, and team logos.

12. The stapling system of claim 10, further comprising an auto-feeding device for dispensing the shaped objects, wherein the auto-feeding device forms an integral part of the second housing of the stapler.

13. The plurality of shaped objects of claim 11, wherein each shaped object further comprises at least one lateral protrusion to assist in stabilizing shaped object in the first or second housing of stapler and wherein the lateral protrusion further comprises at least one aperture passing through each protrusion to receive a portion of a vertical arm of the staple.

14. The plurality of shaped objects of claim 13, wherein the plurality of shaped objects is configured as a strip or cartridge of shaped objects.

15. The stapler of claim 10, wherein the second housing of the stapler further comprises a cutter adapted for using in dispensing individual shaped object from a strip or cartridge of shaped objects.
